(19) United States
(12) Patent Application Publication
(10) Pub. No.: US 2010/0201760 A1
(43) Pub. Date: Aug. 12, 2010

(54) LIQUID EJECTING HEAD, METHOD OF MANUFACTURING THE SAME, AND LIQUID EJECTING APPARATUS

(75) Inventor: Munehide KANAYA, Azumino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/704,422

(22) Filed: Feb. 11, 2010

(30) Foreign Application Priority Data
Feb. 12, 2009 (JP) 2009-029921

(51) Int. Cl. B41J 2/175; B23P 17/00

(52) U.S. Cl. 347/85; 29/890.1

(57) ABSTRACT

A liquid ejecting head includes: a first passageway member which forms a part of a wall surface of a liquid passageway; a second passageway member which forms a part of a wall surface of the liquid passageway different from the first passageway member; and an integral molding member which is formed in the periphery of the liquid passageway so that the first and second passageway members are integrally molded and bonded to each other, wherein the first and second passageway members have a bonding region where the first and second passageway members are bonded to each other in the periphery of the liquid passageway at a boundary between the first and second passageway members, and wherein the integral molding member is formed on the outside of the bonding region.

### BACKGROUND

1. Technical Field

The present invention relates to a liquid ejecting head for ejecting a liquid, a method of manufacturing the same, and a liquid ejecting apparatus, and particularly, to an ink jet printing head for ejecting ink, a method of manufacturing the same, and an ink jet printing apparatus.

2. Related Art

In an ink jet printing head which is a typical example of a liquid ejecting head, generally, ink is supplied from a storage member such as an ink cartridge storing ink to a head body, and the ink supplied to the head body is ejected from a nozzle by driving a pressure generating member such as a piezoelectric element or a heating element.

As this kind of ink jet printing head, there is known an ink jet printing head in which a liquid passageway is provided so as to be opened to bonding surfaces bonded to each other, and a passageway member is provided so as to communicate with the liquid passageway (for example, see JP-A-2002-178541).

However, in the case where two members constituting the passageway member provided with the liquid passageway are bonded to each other by an adhesive, since an adhesive having a low gas permeability generally has a low adhesiveness, problems arise in that an error may occur in an operation of adhering the two members to each other, and a liquid may leak from the adhering region. On the contrary, since an adhesive having a high adhesiveness has a high gas permeability, problems arise in that a gas contained in a liquid inside the liquid passageway leaks to the outside and a gas enters into the passageway from the outside thereof.

In addition, a method may be supposed in which the two members constituting the passageway member are bonded to each other by welding such as heat welding or ultrasonic welding. However, even in the case of the welding, the same problem arises in that a liquid leaks from a bonding region between the two members constituting the passageway members. Further, a method may be supposed in which a material easy for welding and suppressing a liquid from leaking to the outside is used for the two members constituting the passageway member. However, since the material easy for the welding has a poor gas barrier property, problems arise in that a gas contained in a liquid inside the liquid passageway leaks to the outside and a gas enters into the liquid passageway from the outside thereof.

Further, the problems exist in a liquid ejecting head for ejecting a liquid other than ink as well as the ink jet printing head.

### SUMMARY

An advantage of some aspects of the invention is that it provides a liquid ejecting head capable of improving reliability thereof by suppressing leakage of a liquid and improving a gas barrier property, a method of manufacturing the same, and a liquid ejecting apparatus.

According to an aspect of the invention, there is provided a liquid ejecting head including: a first passageway member which forms a part of a wall surface of a liquid passageway; a second passageway member which forms a part of a wall surface of the liquid passageway different from the first passageway member; and an integral molding member which is formed in the periphery of the liquid passageway so that the first and second passageway members are integrally molded and bonded to each other, wherein the first and second passageway members have a bonding region where the first and second passageway members are bonded to each other in the periphery of the liquid passageway at a boundary between the first and second passageway members, and wherein the integral molding member is formed on the outside of the bonding region.

With the above-described configuration, since the first and second passageway members are bonded to each other in the bonding region, and the integral molding member is molded on the outside thereof, it is possible to suppress a part of the integral molding member from flowing into the liquid passageway. In addition, since the first and second passageway members are bonded to each other by molding the integral molding member, it is possible to prevent a liquid from leaking from the boundary between the first and second passageway members. Further, since the first and second passageway members are bonded to each other by molding the integral molding member, a material which has a high gas barrier property and in which a liquid hardly leaks to the outside may be used for the first and second passageway members.

Here, the first and second passageway members may be adhered to each other in the bonding region through an adhesive. Accordingly, it is possible to prevent a part of the adhesive layer formed by an adhesive from flowing into the liquid passageway.

In addition, a fluidity of the unhardened adhesive may be lower than that of the unhardened integral molding member. Accordingly, it is possible to suppress the adhesive, used to adhere the first and second passageway members to each other, from flowing into the liquid passageway.

Further, a gas barrier property of the adhesive may be lower than that of the integral molding member. Accordingly, since a material having a comparatively low gas barrier property has a comparatively high adhesiveness, it is possible to further suppress a melted material, formed of an adhesive having a comparatively high adhesiveness and forming the integral molding member, from flowing into the liquid passageway.

Furthermore, the first and second passageway members may be welded to each other in the bonding region.

Moreover, according to another aspect of the invention, there is provided a liquid ejecting apparatus including the liquid ejecting head.

With the above-described configuration, it is possible to realize the liquid ejecting apparatus capable of improving reliability thereof by suppressing leakage of a liquid and improving a gas barrier property.

According to still another aspect of the invention, there is provided a method of manufacturing a liquid ejecting head including: a first passageway member which forms a part of a wall surface of a liquid passageway; a second passageway member which forms a part of a wall surface of the liquid passageway different from the first passageway member; and an integral molding member which is formed in the periphery of the liquid passageway so that the first and second passageway members are integrally molded and bonded to each other, the method including: bonding the first and second passageway members to each other in a bonding region in the periphery of the liquid passageway at a boundary between the first and second passageway members; and integrally molding the integral molding member on the outside of the bonding region, so that the first and second passageway members are integrally molded and bonded to each other.

With the above-described configuration, since the first and second passageway members are bonded to each other before molding the integral molding member, it is possible to suppress a melted material from flowing into the liquid passageway through the bonding region upon molding the integral molding member. In addition, a material which has a high gas barrier property and in which a liquid hardly leaks to the outside may be used for the first and second passageway members.

### BRIEF DESCRIPTION OF THE DRAWINGS

The invention will be described with reference to the accompanying drawings, wherein like numbers reference like elements.

FIG. 1 is a schematic perspective view illustrating a printing apparatus according to an embodiment of the invention.

FIG. 2 is a sectional view illustrating a passageway member according to the embodiment of the invention.

FIGS. 3A and 3B are sectional views illustrating a method of manufacturing a printing head according to the embodiment of the invention.

FIGS. 4A and 4B are sectional views illustrating the method of manufacturing the printing head according to the embodiment of the invention.

FIG. 5 is a sectional view illustrating the method of manufacturing the printing head according to the embodiment of the invention.

FIG. 6 is a sectional view illustrating a head body according to the embodiment of the invention.

### DESCRIPTION OF EXEMPLARY EMBODIMENTS

Hereinafter, an embodiment of the invention will be described in detail with reference to the accompanying drawings.

### First Embodiment

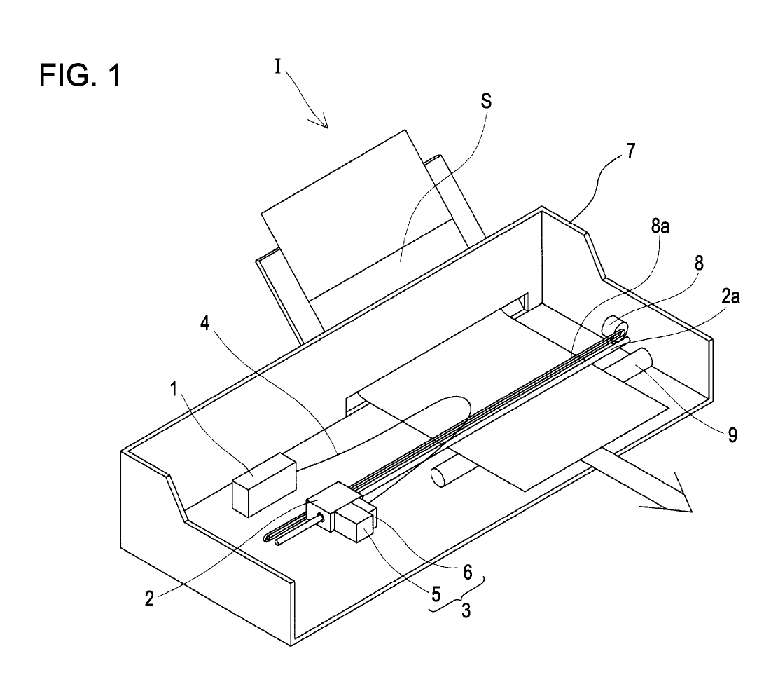

FIG. 1 is a schematic perspective view illustrating an ink jet printing apparatus which is an example of a liquid ejecting head according to the embodiment of the invention. As shown in FIG. 1, in the embodiment, ink of a storage member 1 storing ink therein is supplied to an ink jet printing head 3 mounted onto a carriage 2 through a supply pipe 4. The ink jet printing head 3 includes a head body 5 which is provided with a nozzle passageway for ejecting ink and a passageway member 6 to which the supply pipe 4 for supplying ink from the storage member 1 to the head body 5 is connected.

The carriage 2 mounted onto the ink jet printing head 3 is provided in a carriage shaft 2a, mounted onto an apparatus body 7, so as to be movable in the axial direction.

In addition, when a driving force of a driving motor 8 is transmitted to the carriage 2 through a timing belt 8a and plural gears (not shown), the carriage 2 mounted with the ink jet printing head 3 moves along the carriage shaft 2a. Meanwhile, a platen 9 is provided in the apparatus body 7 along the carriage shaft 2a, and a printing sheet S as a printing medium such as a paper sheet fed by a sheet feeding roller (not shown) is transported while being wound on the platen 9.

In the ink jet printing head I, when the carriage 2 moves along the carriage shaft 2a, ink is ejected from the head body 5 of the ink jet printing head 3 so as to perform a printing process on the printing sheet S.

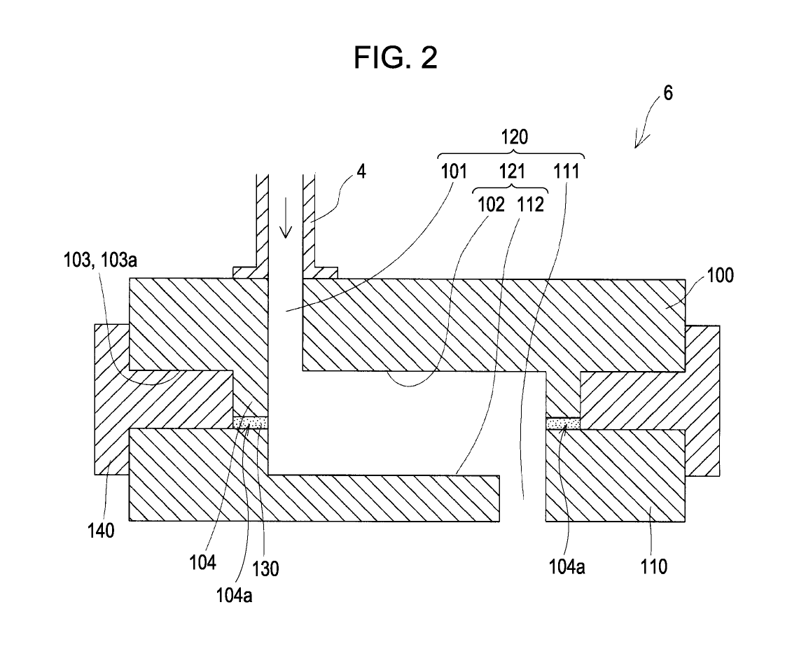

Here, the passageway member 6 constituting a part of the ink jet printing head 3 will be described with reference to FIG. 2. In addition, FIG. 2 is a sectional view showing the passageway member. As shown in FIG. 2, the passageway member 6 includes a first passageway member 100 to which the other end of the supply pipe 4 having one end connected to the storage member 1 is connected and a second passageway member 110 which is bonded to the first passageway member 100 and is connected to the head body 5.

The first passageway member 100 and the second passageway members 110 are provided with a liquid passageway 120 which is used to supply ink from the storage member 1 (supply pipe 4) to the head body 5.

The first passageway member 100 is formed of metal, a resin, or the like. In addition, the first passageway member 100 is provided with an input path 101 which is formed in the thickness direction and of which one end is connected to the supply pipe 4 and a first communication path 102 which is opened to the opposite side of a surface, connected to the supply pipe 4, of the input path 101 and of which one end communicates with the input path 101, the first communication path 102 having a concave shape.

The second passageway member 110 is formed of metal, a resin, or the like. Although the configuration of the second passageway member 110 will be described later in detail, the second passageway member 110 is integrally molded and bonded to a surface where the first communication path 102 of the first passageway member 100 is opened.

The second passageway member 110 is provided with a second communication path 112 which is formed in a concave shape so as to be opened to a surface bonded to the first passageway member 100. In addition, the first passageway member 100 and the second passageway members 110 are integrally molded and bonded to each other so that the first communication path 102 and the second communication path 112 communicate with each other. Accordingly, a communication path 121 is formed by the first and second communication paths 102 and 112. That is, a part of a wall surface of a communication path 121 as a part of a liquid passageway 120 is defined by the first communication path 102 of the first passageway member 100, and the other wall surface of the communication path 121 as a part of the liquid passageway 120 is defined by the second communication path 112 of the second passageway member 110.

In addition, the second passageway member 110 is provided with an output path 111 which is formed in the thickness direction so as to communicate with the opposite end of the end of the communication path 121 communicating with the input path 101. In addition, the other end on the opposite side of one end of the output path 111 communicating with the communication path 121 is connected to the head body (not shown) 5.

Further, in the embodiment, the input path 101 provided in the first passageway member 100 and the second passageway members 110, the communication path 121, and the output path 111 constitute the liquid passageway 120 which supplies ink from the storage member 1 to the head body 5. That is, the ink supplied from the storage member 1 through the supply pipe 4 is supplied to the head body 5 through the input path 101, the communication path 121, and the output path 111.

In the first passageway member 100, a concave portion 103 is provided in the outer periphery of the first communication path 102, and a protrusion portion 104 is provided between the first communication path 102 and the concave portion 103 so as to protrude toward the second passageway member 110. Further, a front end surface of the protrusion portion 104 of the first passageway member 100 is bonded to the second passageway member 110, and the front end surface of the protrusion portion 104 forms a bonding region 104a. Here, the bonding in the bonding region 104a between the first passageway member 100 and the second passageway members 110 indicates a bonding different from an integral forming and bonding to be described later in detail. As the bonding in the bonding region 104a between the first passageway member 100 and the second passageway members 110, for example, adhering using an adhesive, welding using a heat or an ultrasonic wave, or the like may be exemplified.

In the embodiment, the first passageway member 100 is bonded to the second passageway member 110 through an adhesive layer 130 formed in the bonding region 104a by an adhesive. In addition, in a state before the adhesive layer 130 is hardened, that is, a state of the adhesive, it is desirable that the adhesive layer 130 uses an adhesive having a fluidity lower than that of an unhardened integral molding member 140 to be described later in detail. Likewise, since the adhesive having the fluidity lower than that of the unhardened integral molding member 140 is used, when the first passageway member 100 is adhered to the second passageway member 110 through the adhesive, it is possible to prevent the adhesive layer 130 from flowing into the liquid passageway 120 (communication path 121). That is, if the adhesive layer 130 having a comparatively low fluidity is used, the adhesive flows into the liquid passageway 120 when the first passageway member 100 is adhered to the second passageway member 110. In addition, the adhesive flowing into the liquid passageway 120 serves as a foreign material occupying a part of the passageway, or bubbles contained in ink stay at a corner portion defined by the outflow adhesive and the liquid passageway 120, which causes an ejection error.

In addition, it is desirable that the adhesive layer 130 has a gas barrier property lower than that of the integral molding member 140 to be described later in detail. This is because an adhesive having a comparatively high gas barrier property generally has a low adhesiveness and the first passageway member 100 and the second passageway members 110 cannot be reliably adhered to each other by using the adhesive having a comparatively high gas barrier property. In addition, an adhesive having a comparatively low adhesiveness and a high gas barrier property may be used for the purpose of temporarily adhering the first passageway member 100 and the second passageway members 110 to each other through the adhesive layer 130 (adhesive). However, in order to prevent the separated or peeled state during the manufacturing process, it is very desirable to use an adhesive having a comparatively high adhesiveness for the purpose of reliably adhering the first passageway member 100 and the second passageway members 110 to each other. In addition, upon integrally molding the integral molding member 140 to be described later in detail, when the adhesiveness of the adhesive layer 130 is low, a melted resin forming the integral molding member 140 may flow into the liquid passageway 120. For this reason, it is very desirable to use the adhesive having a low gas barrier property and a high adhesiveness. Epoxy resin adhesives are used as the adhesive having a low gas barrier property.

Further, even when the adhesive having a high gas barrier property is used, since the adhering region of the adhesive layer 130 is covered by the integral molding member 140 formed by molding, it is possible to prevent leakage of ink or an entrance of a gas caused by the insufficient adhering strength of the adhesive layer 130.

That is, it is desirable that the adhesive layer 130 has a high adhesiveness. A gas barrier property of the adhesive layer 130 may be low. It is desirable that the integral molding member 140 has a high gas barrier property capable of suppressing an entrance of a gas.

In addition, one surface of the concave portion 103 of the first passageway member 100 is defined by the second passageway portion 110 so as to form a groove portion 103a opened to the side surface of the passageway member 6. Further, the integral molding member 140 is formed inside the groove portion 103a. The integral molding member 140 is formed in the groove portion 103a between the first passageway member 100 and the second passageway members 110 by molding so as to bond (integrally mold and bond) the first passageway member 100 and the second passageway members 110 to each other. That is, the integral molding member 140 is formed to have a shape of the grove portion 103a formed between the first passageway member 100 and the second passageway members 110. In addition, the integral forming and bonding indicates that the integral molding member 140 is formed between the first passageway member 100 and the second passageway members 110 so as to come into contact therewith and to bond the first passageway member 100 and the second passageway members 110 to each other.

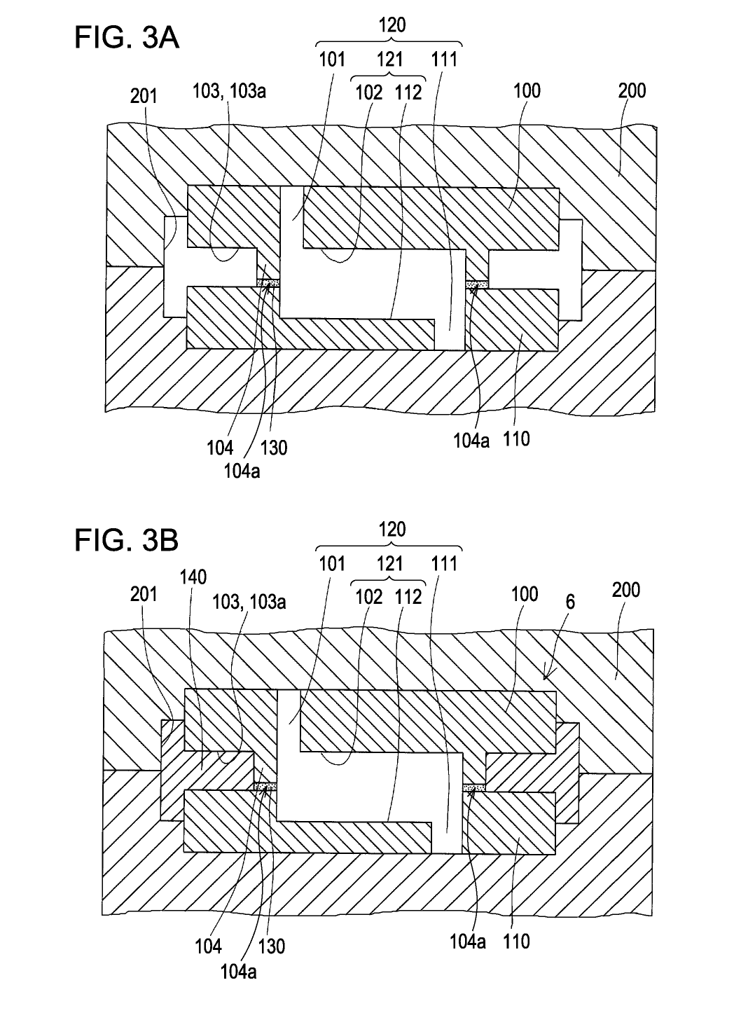

The integral molding member 140 is provided in the groove portion 103a, that is, the outside of the bonding region 104a in the circumferential direction. That is, as described above, the integral molding member 140 is provided so as to shield the bonding region 104a having the adhesive layer 130 used for adhering (bonding) the first passageway member 100 and the second passageway members 110 to each other. In addition, since the integral molding member 140 is formed by molding, it is possible to use a material in which ink hardly leaks to the outside and which has a high gas barrier property. Accordingly, it is possible to prevent a liquid inside the liquid passageway 120 (communication path 121) from leaking to the outside through the bonding region 104a. Here, a method of manufacturing the passageway member 6 will be described in detail. In addition, FIG. 3 is a sectional view illustrating the method of manufacturing the passageway member.

First, as shown in FIG. 3A, a mold 200 is fitted to the first passageway member 100 and the second passageway members 110 bonded to each other in advance through the adhesive layer 130. The mold 200 includes upper and lower separate members, and has a cavity 201 where the integral molding member 140 is formed.

In addition, as shown in FIG. 3B, the passageway member 6 is formed by integrally molding the integral molding member 140. In detail, the integral molding member 140 is formed in such a manner that a melted resin is introduced into a gate (not shown) of the mold 200 so as to be filled into the cavity 201 and the groove portion 103a. At this time, since the periphery of the liquid passageway 120 (communication path 121) provided in the first passageway member 100 and the second passageway members 110 is the bonding region 104a having the adhesive layer 130, it is possible to prevent the melted resin from flowing into the liquid passageway 120 through the adhesive layer 130. That is, the adhesive layer 130 is used to temporarily bond the first passageway member 100 and the second passageway members 110 to each other, and to prevent the melted resin from flowing into the liquid passageway 120.

In addition, when the integral molding member 140 is formed in the state where the first passageway member 100 and the second passageway members 110 come into contact with each other without the adhesive layer 130, the melted resin flows into the liquid passageway 120. The inflow resin serves as a foreign material inside the liquid passageway 120, or the sectional area of the liquid passageway 120 is narrowed by the inflow resin. As a result, a problem arises in that a desired flow rate cannot be obtained.

Further, when the integral molding member 140 is formed in this manner, the first passageway member 100 and the second passageway members 110 are fixed (integrally molded and bonded) to each other so as to be integrated with each other.

Likewise, when the first passageway member 100 and the second passageway members 110 are bonded (integrally molded and bonded) to each other by the integral molding member 140, the bonding region 104a is covered by the integral molding member 140. Accordingly, it is possible to prevent ink from leaking between the first passageway member 100 and the second passageway members 110. That is, when the first passageway member 100 and the second passageway members 110 are integrally bonded to each other by using the integral molding member 140, it is possible to suppress the leakage of ink compared with the case where the first passageway member 100 and the second passageway members 110 are bonded to each other just by using an adhesive or are heat-fixed to each other by using a heat or an ultrasonic wave. Particularly, in the case where the comparatively long communication path 121 is formed as the liquid passageway 120, ink easily leaks from the communication path 121 when the first passageway member 100 and the second passageway members 110 are bonded to each other by adhering or welding. However, when the integral molding member 140 shields the bonding region 104a as a boundary between the first passageway member 100 and the second passageway members 110, it is possible to prevent the leakage of ink regardless of the length of the communication path 121.

Further, since the integral molding member 140 is formed by molding, the integral molding member 140 may be formed of a material having a low gas permeability (a material having a high gas barrier property) such as annular olefin-copolymer (COC), polyphenylene sulfide (PPS), or high-density polyethylene (PE-HD). Likewise, when a material having a low gas permeability is used as the integral molding member 140, it is possible to prevent ink inside the liquid passageway 120 from leaking to the outside and to prevent a gas from entering the liquid passageway 120 from the outside thereof. In addition, since a material having a low gas permeability can be used as the integral molding member 140, a material having a comparatively high gas permeability and a comparatively high adhesiveness can be used as the adhesive layer 130. That is, in the case where the first passageway member 100 and the second passageway members 110 are adhered to each other by using only the adhesive layer 130, when an adhesive having a low gas permeability, but generally having a low adhesiveness is used, an error may occur in an operation of adhering the first passageway member 100 and the second passageway members 110 to each other, and ink may leak from the adhering region. Accordingly, it is difficult to simultaneously have a high adhesiveness and a low gas permeability. However, when the first passageway member 100 and the second passageway members 110 are bonded to each other by using the integral molding member 140, it is easy to simultaneously have a high adhesiveness and a low gas permeability. Epoxy resin adhesives are used as the adhesive having a low gas barrier property.

Further, in the embodiment, since the first passageway member 100 and the second passageway members 110 are bonded to each other by using the integral molding member 140, the first passageway member 100 and the second passageway members 110 may be formed of a material having a high gas barrier property (a low gas permeability) as in the integral molding member 140. Particularly, when the first passageway member 100, the second passageway member 110, and the integral molding member 140 are formed of the same resin, the boundaries therebetween are melted, thereby more reliably bonding them. Accordingly, it is possible to suppress a gas of ink inside the liquid passageway 120 from leaking to the outside and to suppress a gas from entering the liquid passageway 120 from the outside thereof. In addition, in the case where the first passageway member 100 and the second passageway members 110 are bonded to each other by welding, it may be supposed that a material which is easy for welding and the leakage of ink hardly occurs is used for the first passageway member 100 and the second passageway members 110, problems arise in that a material easy for welding has a low gas barrier property and a material having a high gas barrier property is difficult for welding.

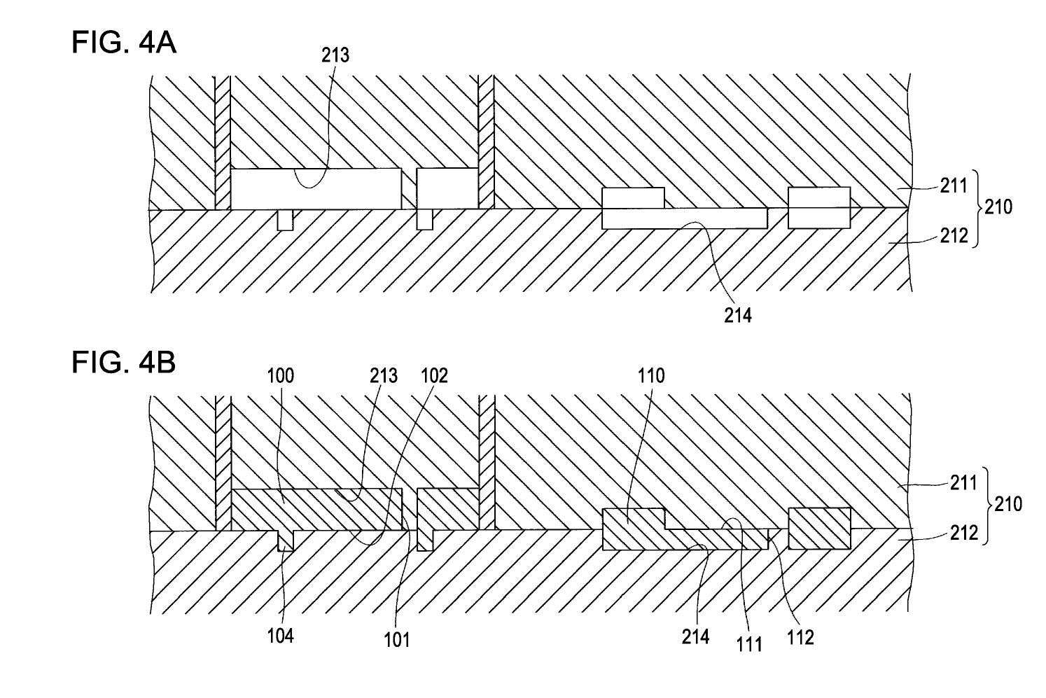

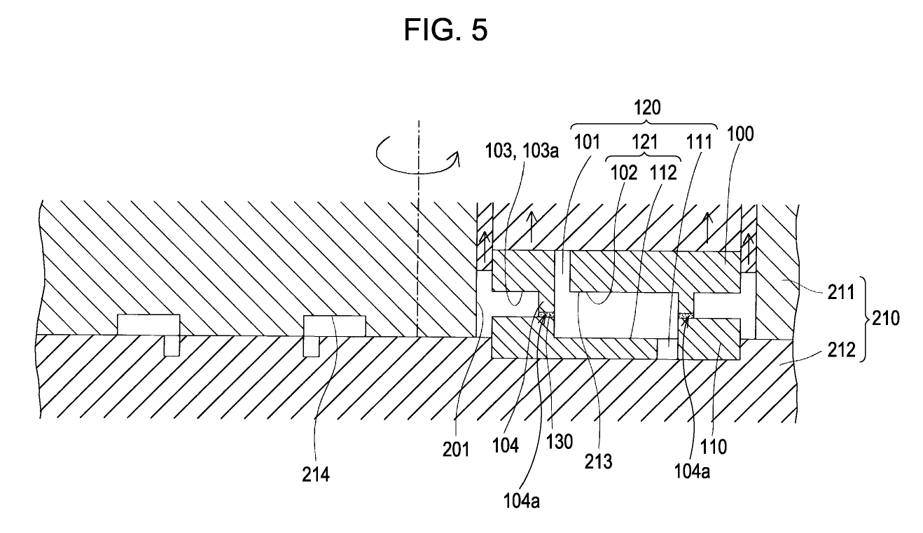

In addition, in the case where the first passageway member 100 and the second passageway members 110 are separately molded, the first passageway member 100 and the second passageway members 110 are simultaneously molded by a mold, and a technique such as a core back is used. In this case, when a process of applying an adhesive is further provided without separating the first passageway member 100 and the second passageway members 110 from the mold, it is possible to form the integral molding member 140. Here, the method will be described with reference to FIGS. 4 and 5. FIGS. 4 and 5 are sectional views illustrating another example of the method of manufacturing the ink jet printing head according to the embodiment of the invention.

First, a mold 210 will be described. As shown in FIG. 4, the mold 210 includes first and second molds 211 and 212 which are separable in the vertical direction. The mold 210 includes a first cavity 213 which has the same shape as that of the first passageway member 100 and is used to mold the first passageway member 100 therein and a second cavity 214 which has the same shape as that of the second passageway member 110 and is used to mold the second passageway member 110 therein.

As shown in FIG. 5, the first mold 211 is rotatably provided on the contact surface of the second mold 212 so that the first cavity 213 is changed to the second cavity 214.

In addition, a part of the first mold 211 defining the first cavity 213 is adapted to move upward on the opposite side of the second mold 212 (core back).

When the passageway member 6 is formed by using the mold 210, first, as shown in FIG. 4A, the first mold 211 and the second mold 212 come into contact with each other so as to define the first cavity 213 and the second cavity 214 in the mold 210. In addition, as shown in FIG. 4B, the melted resin is introduced into a gate (not shown) of the mold 210 so as to be filled into the first cavity 213 and the second cavity 214, thereby molding the first passageway member 100 and the second passageway members 110.

Next, as shown in FIG. 5, the first mold 211 rotates together with the first passageway member 100. At this time, a part of the region having the first passageway member 100 of the first mold 211 moves upward (core back) on the opposite side of the second passageway member 110, and the cavity 201 is defined along the outer periphery of the side surface of the first passageway member 100 and the second passageway members 110 so as to form the integral molding member 140. In addition, at this time, an adhesive is applied between the first passageway member 100 and the second passageway members 110. Further, when the adhesive is hardened, the first passageway member 100 and the second passageway members 110 are bonded to each other through the adhesive layer 130.

In this state, as shown in FIG. 3, when the melted resin is introduced into a gate (not shown) of the mold 210 so as to be filled into the cavity 201, it is possible to mold the integral molding member 140 and to bond (integrally mold and bond) the first and the second passageway members 100 and 110 through the integral forming member 140.

Likewise, in the case where the first passageway member 100 and the second passageway members 110 are separately formed by molding, when a simple process of applying an adhesive on the first and the second molded passageway members 100 and 110 is further provided, it is possible to integrally mold and bond the first passageway member 100 and the second passageway members 110 to each other. Accordingly, it is not necessary to perform a complicated operation, and to improve the yield of the product.

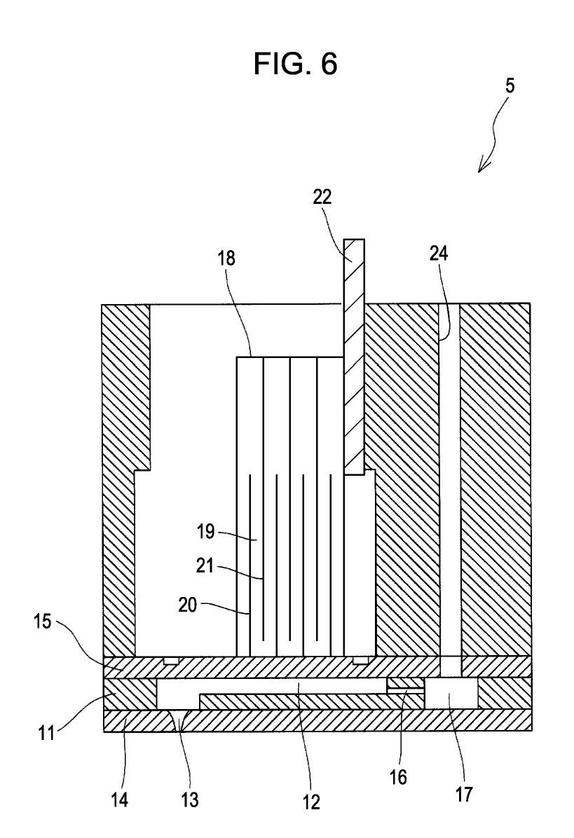

Here, an example of the head body 5 of the ink jet printing head 3 will be described. FIG. 6 is a sectional view illustrating an example of the head body.

The head body 5 shown in FIG. 6 includes a vertical vibration type piezoelectric element. Plural pressure generating chambers 12 are provided in a passageway substrate 11, and both sides of the passageway substrate 11 are sealed by a vibration plate 15 and a nozzle plate 14 having nozzle passageways 13 corresponding to the pressure generating chambers 12. In addition, the passageway substrate 11 is provided with a reservoir 17 which is used as a common ink chamber of the plural pressure generating chambers 12 while communicating with each of the pressure generating chambers 12 through an ink supply port 16. The reservoir 17 is connected to an ink cartridge (not shown).

Meanwhile, in a portion of the vibration plate 15 on the opposite side of the pressure generating chambers 12, piezoelectric elements 18 are provided so that each front end thereof comes into contact with a region corresponding to each of the pressure generating chambers 12. The piezoelectric elements 18 are formed by alternately laminating a piezoelectric material 19 and electrode forming materials 20 and 21, and an inactive region not used for the vibration is fixed to a fixed substrate 22.

In the head body 5 having the above-described configuration, ink is supplied to the reservoir 17 through a passageway 24 communicating with the liquid passageway 120 of the passageway member 6, and is distributed to the pressure generating chambers 12 through the ink supply ports 16. In addition, when a voltage is applied to the piezoelectric element 18, it is possible to contract the piezoelectric element 18. Accordingly, the vibration plate 15 is deformed (pulled up in the drawing) together with the piezoelectric element 18 so that the volume of the pressure generating chamber 12 increases, and hence ink is pulled into the pressure generating chamber 12. In addition, after ink is filled in the pressure generating chamber 12 until the ink arrives at the nozzle passageway 13, when the voltage applied to the electrode forming materials 20 and 21 of the piezoelectric element 18 is canceled in response to a printing signal from the driving circuit, the piezoelectric element 18 expands so as to return to the original state. Accordingly, since the vibration plate 15 displaces so as to return to the original state, the pressure generating chamber 12 contracts so that the inner pressure thereof increases, and hence ink droplets are ejected from the nozzle passageway 13. That is, in the embodiment, the vertical vibration type piezoelectric element 18 is provided as a pressure generating member that causes a variation in pressure inside the pressure generating chamber 12.

### Other Embodiments

While the embodiment of the invention is described above, the basic configuration of the invention is not limited thereto. For example, in the above-described embodiment, the integral molding member 140 is provided only on the side surface of the passageway member 6. However, when the integral molding member 140 is provided so as to extend to the pair of surfaces where the liquid passageway 120 of the passageway member 6 is opened, it is possible to further improve the adhering strength upon integrally molding and bonding the first passageway member 100 and the second passageway member 110 to each other.

Further, in the above-described embodiment, the first passageway member 100 and the second passageway members 110 are bonded to each other in the bonding region 104a in the periphery of the liquid passageway 120 through the adhesive layer 130 formed of an adhesive, but the invention is not limited thereto. For example, the first passageway member 100 and the second passageway members 110 may be bonded to each other in the bonding region 104a by welding.

Furthermore, for example, in the above-described embodiment, the ink jet printing head 3 is exemplified which includes the passageway member 6 and the head body 5, but for example, a member corresponding to the passageway member 6 may be provided in the course of the supply pipe 4 or may be provided between the storage member 1 and the supply pipe 4. That is, when all constituents from the storage member 1 to the head body 5 are defined as the ink jet printing head, the passageway member 6 may be provided any one side of the portion from the storage member 1 to the head body 5. Of course, a part of the head body 5 may be provided with the passageway member 6.

In the above-described embodiment, the passageway member 6 provided with the liquid passageway 120 is exemplified, but the passageway member 6 may be provided with, for example, a filter, a valve mechanism, a heating member, or the like. Further, in the above-described embodiment, the ink jet printing apparatus I is exemplified in which only the ink jet printing head 3 is mounted onto the carriage 2 without mounting the storage member 1 onto the carriage 2, but the invention is not particularly limited thereto. For example, the storage member 1 may be mounted onto the carriage 2 together with the ink jet printing head 3. In this case, the passageway member may be provided with a supply needle or the like into which the storage member 1 is inserted.

In addition, the number or the arrangement of the liquid passageway 120 provided in the passageway member 6 is not limited to the above-described embodiment, but for example, two or more separate liquid passageways 120 may be provided, or the liquid passageway may have the common input path 101 and the plural divided output paths 111. Further, in the above-described embodiment, in the liquid passageway 120, the communication path 121 is provided so as to extend in a direction parallel to the bonding surface between the first passageway member 100 and the second passageway members 110, but the invention is not limited thereto. For example, in the liquid passageway 120, the input path 101 extending in a direction perpendicular to the bonding surface may be provided so as to communicate with the output path 111 extending in a direction perpendicular to the bonding surface.

Further, the ink jet printing apparatus I is exemplified in which the ink jet printing head 3 is mounted onto the carriage 2 and moves in a main scanning direction, but the invention is not particularly limited thereto. For example, the invention may be applied to a so-called line type printing apparatus in which the ink jet printing head 3 is fixed and a printing process is performed by moving a printing sheet S such as a paper sheet in a sub-scanning direction.

Furthermore, in the above-described embodiment, the actuator device using the vertical vibration type piezoelectric element is used as a pressure generating member for causing a variation in pressure in the pressure generating chamber 12, but the invention is not particularly limited thereto. For example, an actuator device including a thin-film-type piezoelectric element formed by laminating a lower electrode, a piezoelectric layer, and an upper electrode through a film formation or lithography or a thick-film-type actuator device formed by attaching a green sheet may be used. In addition, as a pressure generating member, a member may be used in which heating elements are arranged inside the pressure generating chamber 12 and which ejects liquid droplets from a nozzle passageway by using bubbles generated by a heating of the heating elements, or a so-called electrostatic actuator may be used in which an static electricity is generated between a vibration plate and an electrode and which ejects liquid droplets from a nozzle passageway by deforming the vibration plate using an electrostatic force.

Moreover, the invention is contrived for a wide variety of liquid ejecting heads, and may be applied to, for example, printing heads such as various ink jet printing heads used for an image printing apparatus such as a printer, color material ejecting heads used for manufacturing a color filter such as a liquid crystal display, electrode material ejecting heads used for forming electrodes of an organic EL display, a FED (Field Emission Display), or the like, and biological organic material ejecting heads used for manufacturing a biochip. In addition, the ink jet printing apparatus I is exemplified as an example of the liquid ejecting apparatus, but a liquid ejecting apparatus using the above-described other liquid ejecting heads may be used.

What is claimed is:

1. A liquid ejecting head comprising:
a first passageway member which forms a part of a wall surface of a liquid passageway;
a second passageway member which forms a part of a wall surface of the liquid passageway different from the first passageway member; and
an integral molding member which is formed in the periphery of the liquid passageway so that the first and second passageway members are integrally molded and bonded to each other,
wherein the first and second passageway members have a bonding region where the first and second passageway members are bonded to each other in the periphery of the liquid passageway at a boundary between the first and second passageway members, and
wherein the integral molding member is formed on the outside of the bonding region.

2. The liquid ejecting head according to claim 1,
wherein the first and second passageway members are adhered to each other in the bonding region through an adhesive.

3. The liquid ejecting head according to claim 2,
wherein a fluidity of the unhardened adhesive is lower than that of the unhardened integral molding member.

4. The liquid ejecting head according to claim 2,
wherein a gas barrier property of the adhesive is lower than that of the integral molding member.

5. The liquid ejecting head according to claim 1,
wherein the first and second passageway members are welded to each other in the bonding region.

6. A liquid ejecting apparatus comprising:
the liquid ejecting head according to claim 1.

7. A method of manufacturing a liquid ejecting head including: a first passageway member which forms a part of a wall surface of a liquid passageway; a second passageway member which forms a part of a wall surface of the liquid passageway different from the first passageway member; and an integral molding member which is formed in the periphery of the liquid passageway so that the first and second passageway members are integrally molded and bonded to each other, the method comprising:
bonding the first and second passageway members to each other in a bonding region in the periphery of the liquid passageway at a boundary between the first and second passageway members; and
integrally molding the integral molding member on the outside of the bonding region, so that the first and second passageway members are integrally molded and bonded to each other.
